(19) United States
(12) Patent Application Publication
(10) Pub. No.: US 2003/0021572 A1
(43) Pub. Date: Jan. 30, 2003

(54) V-groove with tapered depth and method for making

(76) Inventor: Dan A. Steinberg, Blacksburg, VA (US)

Correspondence Address: HALEOS, INC., 3150 STATE STREET, BLACKSBURG, VA, 24060, US

(21) Appl. No.: 10/067,218

(22) Filed: Feb. 7, 2002

Related U.S. Application Data
(60) Provisional application No. 60/266,931, filed on Feb. 7, 2001.
(60) Provisional application No. 60/299,889, filed on Jun. 21, 2001.

(51) Int. Cl. G02B 6/36; C03C 15/00

(52) U.S. Cl. 385/137; 385/83; 216/24

(57) ABSTRACT

A method of forming a tapered V-groove in a <100>silicon substrate is described. Spaced apart pits are dry etched in the substrate and sidewalls of the pits are masked. Then, sections of the substrate are wet-etched to connect the spaced apart pits. Each successive wet-etched section has a different width, and hence depth, than the preceding wet-etched section. In one aspect, each succeeding wet-etched section is not as wide, and hence more shallow, than the preceding wet-etched section. Also, each succeeding pit has a smaller cross-sectional area than the preceding pit.

### CROSS-REFERENCE TO RELATED APPLICATIONS

This application claims priority from provisional applications serial No. 60/266,931, filed Feb. 7, 2001, and No. 60/299,889, filed Jun. 21, 2001, the entire disclosures of which are incorporated herein by reference.

### FIELD OF THE INVENTION

The invention relates to the formation of V-grooves in substrates for use with optical devices.

### BACKGROUND

Some optical devices utilize grooves in a substrate for mounting optical fibers. Generally, grooves formed in the substrate are etched in a V-shaped profile. Such a V-shaped profile can be formed in a <100> silicon substrate by anisotropically etching along <111> crystalline planes.

Some optical devices require V-grooves having a depth that varies along the length of the V-groove. As the depth of such V-grooves decreases, the V-groove width tapers inwardly. A disadvantage in anisotropically etching varying depth V-grooves in <100> silicon is that such V-grooves are difficult to make in <100> silicon because a tapered mask used to pattern the varying depth V-groove does not align with the <111> crystalline planes of the substrate. Although a varying depth V-groove can be made in a <100> substrate by cutting the substrate at an offset angle and then etching in the V-groove with an anisotropic wet etchant, this is an expensive undertaking. An example of a varying depth V-groove made in a <100> substrate is shown in FIG. 1. Specifically, a substrate 2 is illustrated including a tapered V-groove 6 in a first surface 4. The groove 6 tapers from a wide and deep portion at one end to a narrow and shallow portion at an opposite end.

There is thus a need for a less expensive method to prepare V-grooves of varying depth in <100> silicon substrates.

### SUMMARY

The invention provides a method for forming a varying width V-groove in a substrate. The method includes the steps of dry etching at least one pit in the substrate, coating sides of the at least one pit with a material which is resistant to a wet etchant, and wet etching sections of the substrate that join with the at least one pit.

The invention further provides a tapered V-groove formed in a <100> silicon substrate. The V-groove includes a plurality of spaced apart pits and at least two wet-etched sections. A first wet-etched section has a different depth than a second of the wet-etched sections.

The invention further provides an optical coupler that includes a substrate having a tapered V-groove formed of a plurality of spaced apart dry-etched pits joined together with wet-etched sections of varying width, and an optical fiber mounted in said V-groove.

These and other advantages and features of the invention will be more readily understood from the following detailed description of the invention that is provided in connection with the accompanying drawings.

### BRIEF DESCRIPTION OF THE DRAWINGS

FIG. 1 is a perspective view of a conventional substrate with a tapered V-groove.

FIG. 2 is a partial top view illustrating the formation of a tapered V-groove in a substrate in accordance with an embodiment of the invention.

FIG. 3 is a partial perspective view of the tapered V-groove of FIG. 2.

FIG. 4 is a partial top view illustrating the formation of a tapered V-groove in accordance with another embodiment of the invention.

FIG. 5 is a perspective view of the tapered V-groove of FIG. 4.

FIG. 6 is a cross-sectional view of a tapered V-groove constructed in accordance with another embodiment of the invention.

FIG. 7 is a partial top view of a tapered V-groove constructed in accordance with another embodiment of the invention.

FIG. 8 is a cross-sectional view illustrating the formation of a bowed optical fiber mounted on a tapered V-groove in accordance with another embodiment of the invention.

FIGS. 9-15 illustrate process steps for forming a tapered V-groove in accordance with an embodiment of the invention.

FIGS. 16-20 illustrate process steps for forming a tapered V-groove in accordance with another embodiment of the invention.

FIG. 21 illustrates a wedge formed at a location where a groove and pit meet.

### DETAILED DESCRIPTION OF PREFERRED EMBODIMENTS

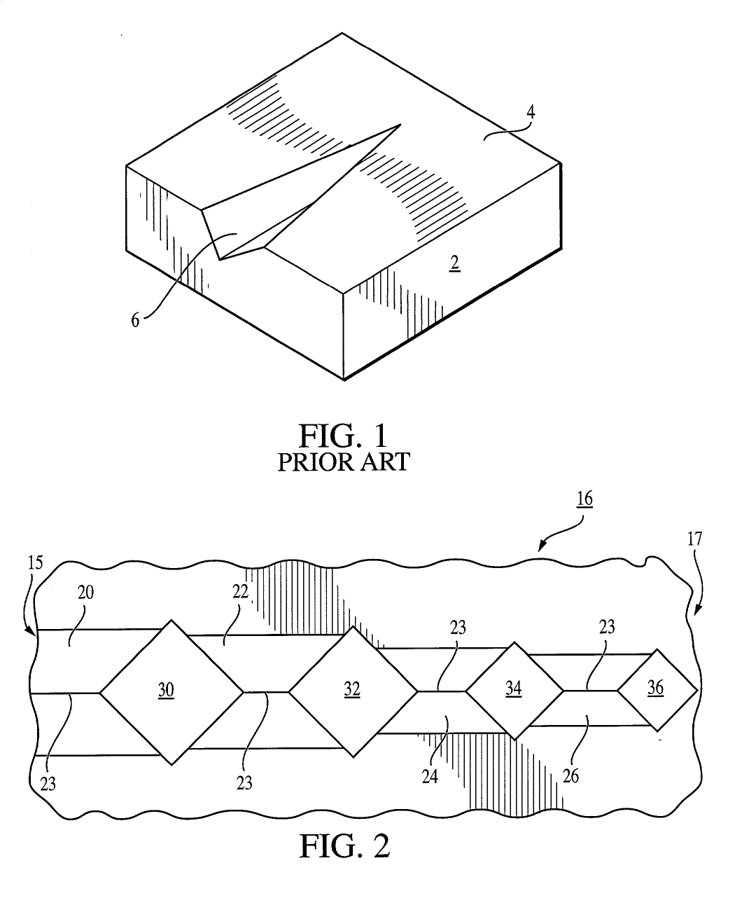

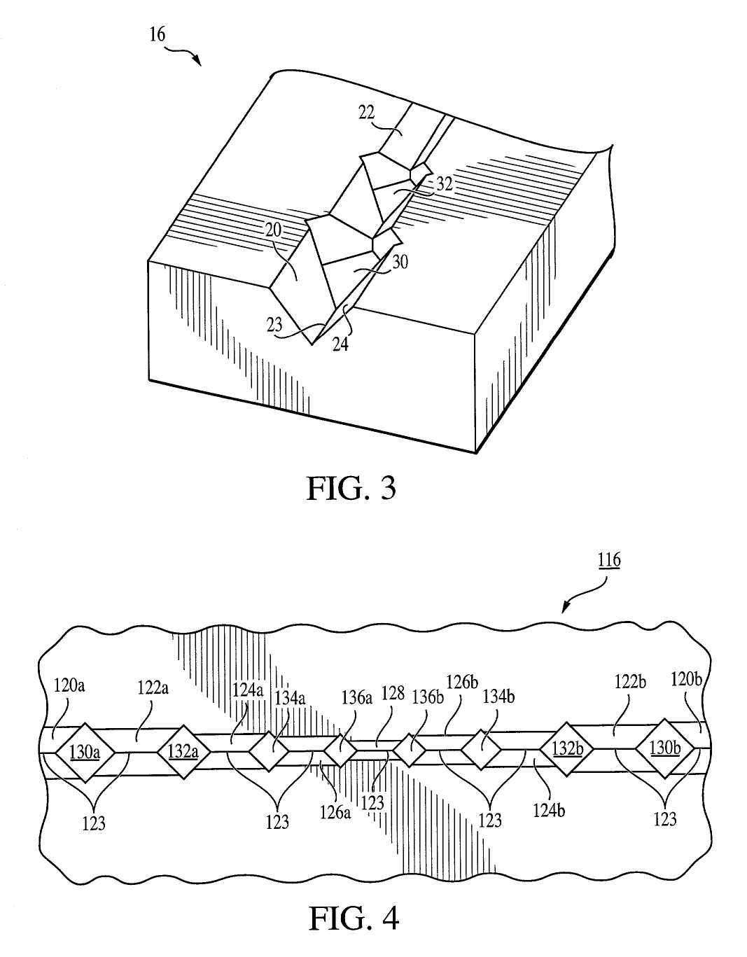

Referring now to FIGS. 2-3, there will be described a substrate 12 that includes a tapered V-groove 16 in a first surface 14. The groove 16 tapers from a wide and deep portion at one end 15 to a narrow and shallow portion at an opposite end 17. Next, the method of making the groove 16 will be described.

Tapered grooves, such as the groove 16, are difficult to form in a <100> silicon using wet anisotropic etching alone. The groove 16 is formed through the combined use of wet and dry etching. Specifically, wet etching is used to create a series of V-groove sections that are joined together by spaced apart pits formed through dry etching. As shown in FIGS. 2-3, a first V-groove section 20 is joined to a second section 22 through a first pit 30. The second V-groove section 22 is joined with a third section 24 through a second pit 32. The third V-groove section 24 is joined to a fourth V-groove section 26 through a third pit 34. A fourth pit 36 acts as a terminus for the V-groove 16 and connects with the fourth V-groove section 26. The V-groove sections 20-26 are wet etched, and the pits 30-36 are dry etched.

Each successive V-groove section 20, 22, 24, 26 has a smaller width and depth than the preceding section. Specifically, the first section 20 is wider, and hence deeper, than the second section 22, which is wider and deeper than the third section 24, which in turn is wider and deeper than the fourth section 26. Also, each successive pit has a smaller cross-sectional area than the preceding pit, namely pit 30 has a larger area than pit 32, which has a larger area than pit 34, which in turn has a larger area than pit 36. Each of the V-groove sections 20,22, 24, 26 include a midline 23 at a base of the sections. The midline 23 serves as a line where each side of the V-groove sections 20, 22, 24, 26 meets the other side. The separated portions of the midline 23 are aligned one with the other.

To form the V-groove 16, the pits 30, 32, 34, 36 are first dry etched in the substrate 12. Suitable dry etching methods may include high-aspect ratio dry etching, deep reactive ion etching, ion beam milling, laser-chemical etching, laser ablation, or laser drilling. The walls of the pits 30, 32, 34, 36 may be vertical or sloped. After the pits 30, 32, 34, 36 are formed, the walls of the pits are coated with a material resistant to anisotropic wet etching with, for example, a potassium hydroxide etchant. Some suitable coatings are silicon nitride or silicon dioxide and may be chemically (CVD) or thermally deposited.

After the coating, the V-groove sections 20-26 are formed, and after formation of the V-groove sections the coating is removed. As illustrated in FIGS. 2-3, the dry etched pits 30, 32, 34, 36 are formed in a diamond shape relative to the V-groove sections 20,22, 24, 26. By forming the pits 30, 32, 34, 36 in a diamond shape, where two corners are generally aligned with the midline 23 and the other two corners are transverse to the midline 23, the formation of wedges is suppressed. While the pits 30, 32, 34, 36 are shown to be diamond-shaped, any shape which provides a projection into the V-groove sections may be used to join up adjacent V-groove sections and suppress the formation of wedges. The surface area in a top view of the pit must be large enough to encompass the area of the V-groove in which a wedge is formed. FIG. 21 illustrates a pit 300 which has an insufficiently large or shaped area, and hence a wedge 302 is formed at a location between a groove 304 and the pit 300.

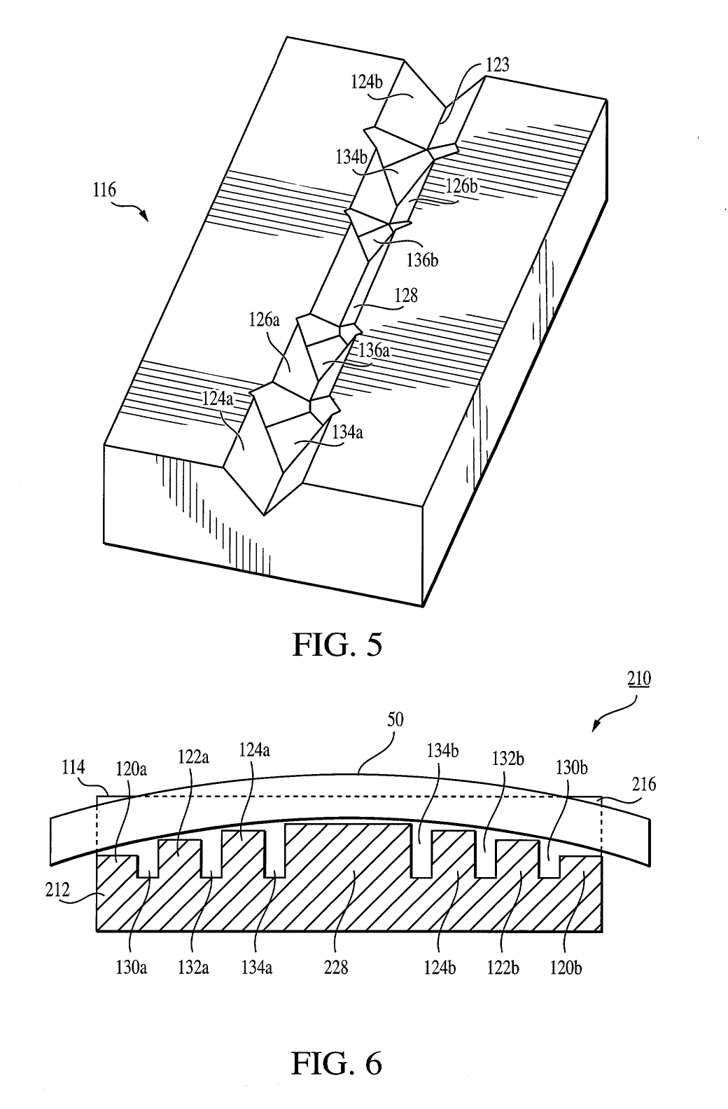

As shown in FIGS. 4-5, a V-groove 116 can be formed in a top surface 114 of a substrate 112 which tapers from deep to shallow to deep. As shown, the V-groove 116 includes first groove sections 120a and 120b of the same width which are respectively joined up with second groove sections 122a and 122b by first pits 130a, 130b. The second groove sections 122a, 122b are not as wide or deep as the first groove sections 120a and 120b. The second groove sections 122a, 122b are joined with less wide and shallower third groove sections 124a, 124b by second pits 132a, 132b. The third groove sections 124a, 124b are joined to less wide and shallower fourth groove sections 126a, 126b by third pits 134a, 134b. Finally, fourth dry pits 136a, 136b act to join the fourth groove sections 126a, 126b to a fifth groove section 128, which is less wide and shallower than the fourth groove sections 126a, 126b. As illustrated, pits 130a, 130b are generally the same size, as are each of the other pairs of pits (132a,b, 134a,b and 136a,b). Further, the pits 130a,b have a greater cross-sectional area than the pits 132a,b, which have a greater area than the pits 134a,b, which in turn are larger than the pits 136a,b. It should be understood, however, that one of the pairs of pits may be of a different size than the other pair, as long as the pits are sufficiently large and appropriately shaped to inhibit the formation of wedges. The V-groove 116 is only partially illustrated in FIG. 5 for simplicity of illustration.

Each of the V-groove sections 122a, 122b, 124a, 124b, 126a, 126b, and 128, has a pair of sides which meet at a midline 123. As illustrated, the midline 123 is in a line from one V-groove section to another. Each of the pits 130a,b, 132a,b, 134a,b and 136a,b, are in a diamond shape, where two corners are generally aligned with the midline 123 and the other two corners are transverse to the midline 123, thereby suppressing the formation of wedges.

FIG. 6 illustrates a V-groove 216 from a side in cross-section in a substrate 212. The number of V-groove sections and pits illustrated in FIG. 6 has been reduced relative to the number shown in FIG. 4. Specifically, V-groove sections 126a, 126b and pits 136a, 136b are not shown in FIG. 6, and section 228 is a longer V-groove section than V-groove section 128. As shown, the V-groove sections 120a, 120b are etched deeper into the substrate 112 than the V-groove sections 122a, 122b, 124a, 124b, and 128. The V-groove sections 122a,b are deeper than the sections 124a,b, which in turn are deeper than the V-groove section 128. This allows a bowed optical fiber 50 to be mounted in the V-groove 116 to form an optical coupler 210.

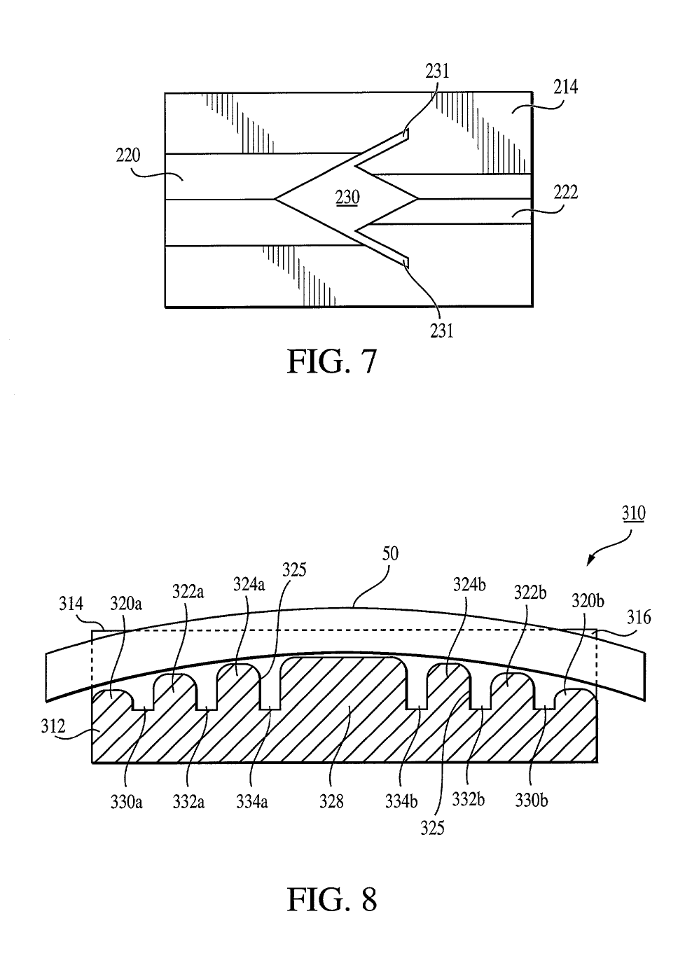

Although the dry etched pits shown in FIGS. 2-6 are diamond shaped, other shapes may be used. As shown in FIG. 7, a pit 230 may be dry etched in a top surface 214 of the substrate to connect a broader and deeper V-section 220 with a less wide and shallower V-section 222. The elongated diamond-shaped pit 230 with wings 231 allows a minimum spacing between the adjacent V-grooves 220, 222. As illustrated, the V-groove section 220 may be etched all the way up to the wings on the pit 230.

After dry etching the pits and wet etching the V-groove sections in a substrate, the substrate can be smoothed to reduce surface roughness. A substrate 312 is shown in FIG. 8 as including a V-groove 316 formed of V-groove sections 320a, 320b, 322a, 322b, 324a, 324b, and 328, and dry-etched pits 330a, 330b, 332a, 332b, 334a and 334b. The top surface 314 of the substrate 312 is smoothed. Further, sharp edges which can form at the edge of the dry-etched pits are smoothed to smoothed corners 325. Smoothing of the top surface 314 and the edges of the dry-etched pits may be accomplished through a light etching. Alternatively, smoothing may be performed through thermal oxidation, followed by an oxide etch. A bowed fiber 50 is mounted in the V-groove 316 to form an optical coupler 310.

While the illustrated substrates have been described as mounts for bowed optical fibers, the illustrated substrates may further be used as a jig for making angle-polished optical fibers. Optical fibers are angle polished to take advantage of reflective properties of the endface of the fiber. Angle-polished optical fibers require that a precise amount of an optical fiber be removed through polishing. An optical fiber may be disposed in the V-groove 16, 116, 316. Generally, the optical fiber is covered with an adhesive, such as, for example, solder glass or epoxy. Then, the optical fiber is polished, removing the adhesive and a portion of the optical fiber until it is flush with the top surface 14, 114, 314 of the substrate 12, 212, 312. Through this process, an optical fiber is produced having an angle polish and the angle of the polish is determined by the V-groove angle.

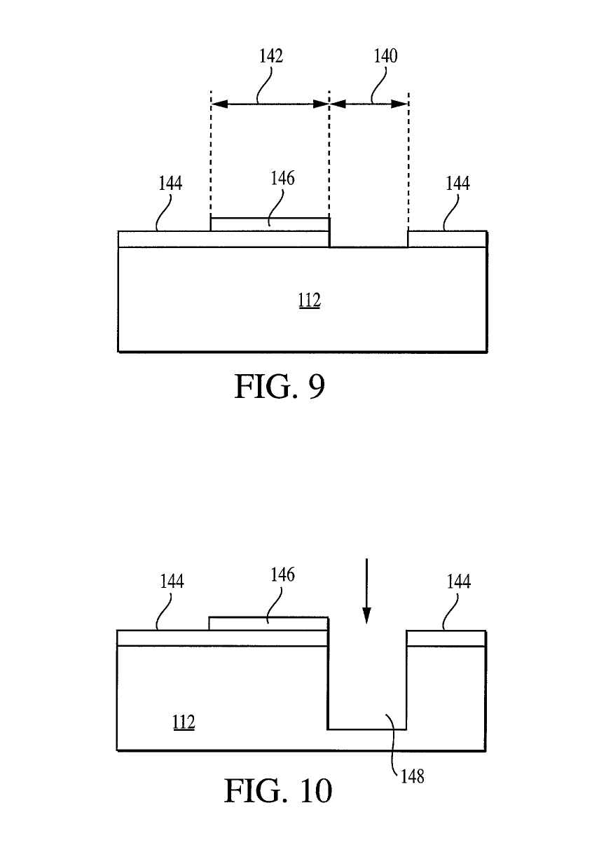

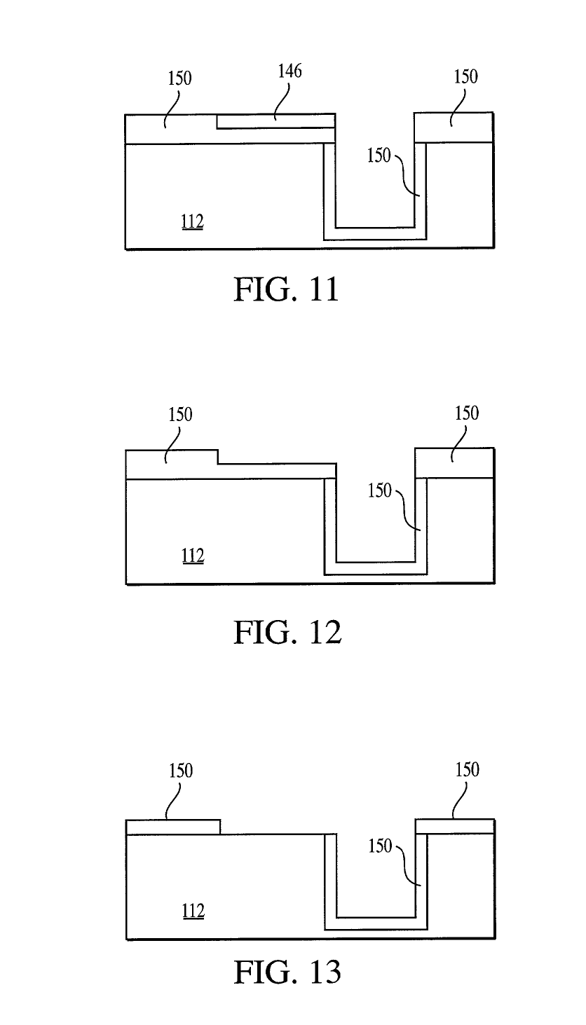

With particular reference to FIGS. 9-15 and 21, next will be described a method for forming a varying width V-groove in a <100> silicon substrate 112. As specifically illustrated in FIG. 9, a silicon dioxide mask 144 is patterned on the substrate 112 to leave uncovered a dry etch area 140. A silicon nitride mask 146 is patterned over the silicon dioxide mask 144 to create a wet etch area 142. The dry pit 148 (FIG. 10) is etched by way of any suitable dry etching methodology, such as, for example, high-aspect ratio dry etching, deep reactive ion etching, ion beam milling, laser-chemical etching, laser ablation, or laser drilling. After dry etching the pit 148, the substrate 112 is thermally oxidized, creating oxidized areas 150 (FIG. 11) surrounding the pit 148 and at an upper portion of the substrate 112. Utilizing a wet etch, the nitride mask 146 is removed (FIG. 12).

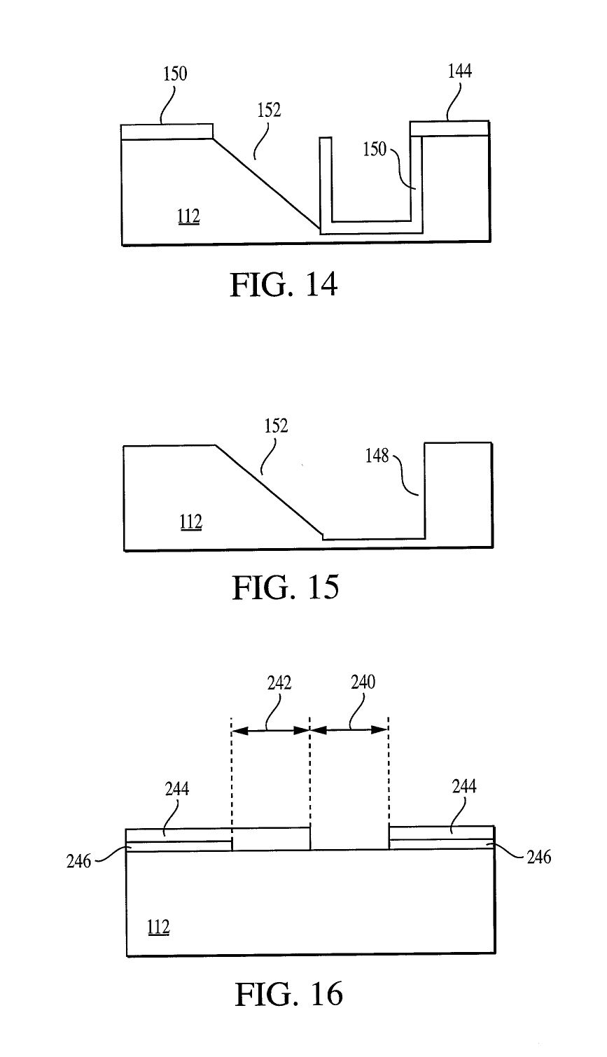

Following removal of the nitride mask 146, the substrate 112 is subjected to a short duration oxide etch that removes the oxide area 150 that had been located beneath the nitride mask 146 (FIG. 13). Other oxide areas 150, which were thicker, remain. The substrate 112 is then exposed to an anisotropic wet etch to create the V-groove 152 (FIG. 14). After formation of the V-groove 152, the remaining oxide areas 150 are removed leaving the substrate 112 with a V-groove 152 connected with a dry pit 148. One suitable removal method includes using a dilute hydrogen fluoride etch.

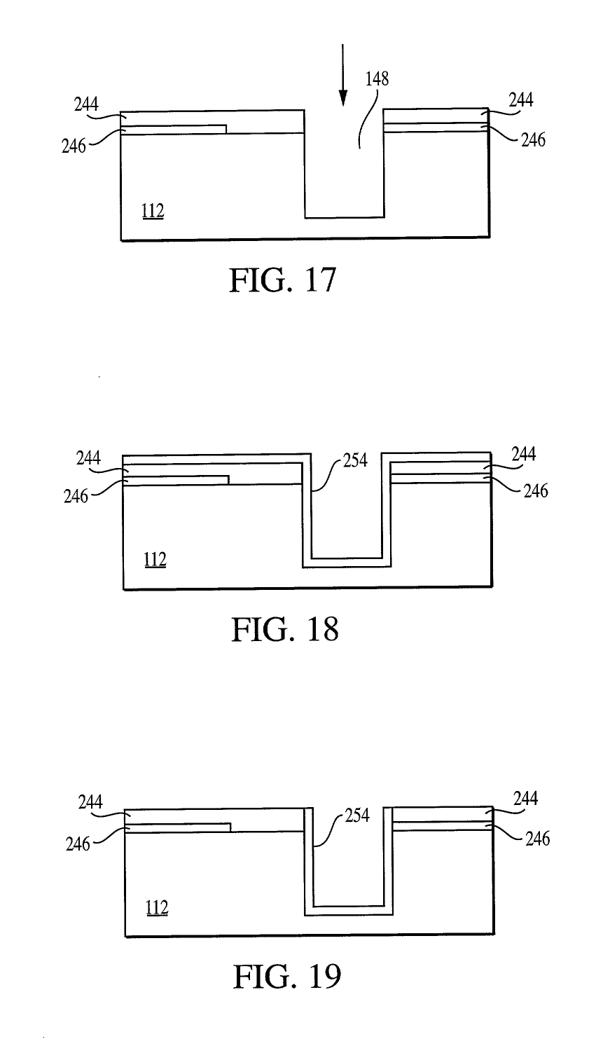

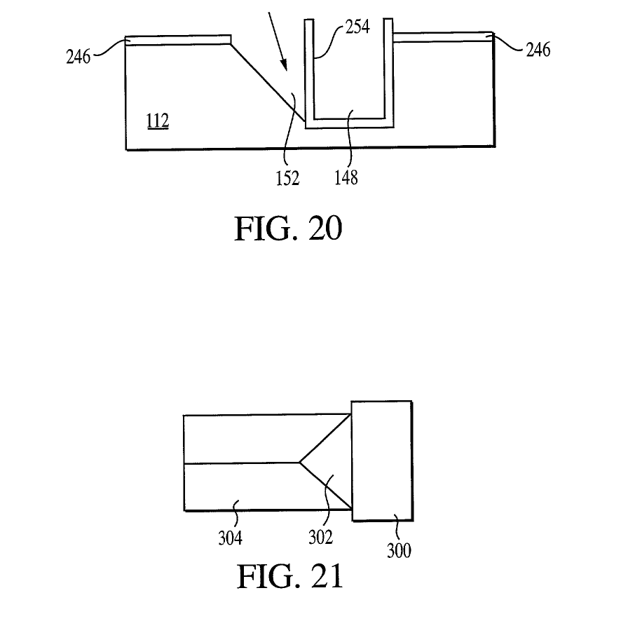

Next, with reference to FIGS. 16-20 will be described an alternative process for forming a varying width V-groove in a <100> silicon substrate 112. FIG. 16 illustrates a silicon nitride mask 246 patterned on the substrate 112. The mask 246 is patterned such that it leaves uncovered a dry etch area 240 and a wet etch area 242. A silicon dioxide mask 244 is patterned over the silicon nitride mask 246. The silicon dioxide mask 244 leaves uncovered the dry etch area 240 and covers up the wet etch area 242. A dry pit 148 (FIG. 17) is etched by way of any suitable dry etching methodology, such as, for example, high-aspect ratio dry etching, deep reactive ion etching, ion beam milling, laser-chemical etching, laser ablation, or laser drilling. After dry etching the pit 148, a CVD nitride layer 254 is conformally coated over the silicon dioxide mask 244 and on the sidewalls of the pit 248 (FIG. 18). The substrate 112 is then planarized or polished to remove the CVD nitride layer 254 except within the pit 148 (FIG. 19). The substrate 112 is then exposed to an anisotropic wet etch to create the V-groove 152 (FIG. 20). After formation of the V-groove 152, the remaining oxide areas 150 are removed leaving the substrate 112 with a V-groove 152 connected with a dry pit 148 (FIG. 15).

While the invention has been described in detail in connection with exemplary embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. For example, although the grooves have been illustrated and described as being V-grooves, the grooves may take any suitable configuration, such as U-grooves. Accordingly, the invention is not to be seen as limited by the foregoing description, but is only limited by the scope of the appended claims.

What is claimed as new and desired to be protected by Letters Patent of the United States is:

1. A method for forming a V-groove in a substrate having a varying width, comprising the steps of:
dry etching at least one pit in the substrate;
coating sides of the at least one pit with a material which is resistant to a wet etchant; and
wet etching sections of the substrate, wherein the at least one pit projects into the sections.

2. The method of claim 1, wherein said dry etching step comprises dry etching first, second and third pits in the substrate.

3. The method of claim 2, wherein said wet etching step comprises wet etching a first section of the substrate between the first and second pits and wet etching a second section of the substrate between the second and third pits.

4. The method of claim 3, wherein the first section has a different width than the second section.

5. The method of claim 4, wherein the first section is wider than the second section.

6. The method of claim 1, wherein said dry etching comprises at least one of the group consisting of deep reactive ion etching, ion beam milling, laser-chemical etching, laser ablation, and laser drilling.

7. The method of claim 1, wherein said coating step comprises coating sides of the at least one pit with a material comprising silicon nitride.

8. The method of claim 1, wherein said coating step comprises coating sides of the at least one pit with a material comprising silicon dioxide.

9. The method of claim 1, further comprising removing said coating.

10. The method of claim 1, wherein said wet-etching sections comprises wet-etching V-grooves.

11. The method of claim 1, wherein said wet-etching sections comprises wet-etching U-grooves.

12. The method of claim 1, further comprising smoothing corners of the at least one pit.

13. The method of claim 12, wherein said smoothing comprises etching.

14. The method of claim 12, wherein said smoothing comprises thermal oxidation.

15. A tapered groove formed in a <100> silicon substrate, comprising:
a pit, wherein the pit extends into the groove such that the pit inhibits the formation of a wedge; and
at least two wet-etched sections, wherein a first said wet-etched section has a different width than a second said wet-etched section.

16. The groove of claim 15, comprising first, second and third pits in the substrate.

17. The groove of claim 16, wherein said first wet-etched section is between said first and second pits and said second wet-etched section is between said second and third pits.

18. The groove of claim 17, wherein said first wet-etched section is wider than said second wet-etched section.

19. The groove of claim 15, wherein said pits have a diamond-shaped profile.

20. The groove of claim 19, wherein said pits include wings.

21. The groove of claim 15, wherein said pits are shaped to inhibit wedges.

22. The groove of claim 21, wherein corners of said pits are smoothed.

23. An optical coupler, comprising:
a substrate having a tapered groove formed of a plurality of spaced apart dry-etched pits joined together with wet-etched sections of varying width; and
an optical fiber mounted in said tapered groove.

24. The optical coupler of claim 23, wherein said optical fiber is bowed.

25. The optical coupler of claim 23, wherein said substrate comprises first, second and third pits.

26. The optical coupler of claim 25, wherein said substrate comprises first and second wet-etched sections, said first wet-etched section is between said first and second pits and said second wet etched section is between said second and third pits.

27. The optical coupler of claim 26, wherein said first wet-etched section is wider than said second wet-etched section.

28. The optical coupler of claim 23, wherein said pits have a diamond-shaped profile.

29. The optical coupler of claim 28, wherein said pits include wings.

30. The optical coupler of claim 23, wherein said pits are shaped to inhibit wedges.

31. The optical coupler of claim 30, wherein corners of said pits are smoothed.
